(19) United States
(12) Patent Application Publication
(10) Pub. No.: US 2010/0109506 A1
(43) Pub. Date: May 6, 2010

(54) LAMINATED FLAT LAMP AND ITS MANUFACTURING PROCESS

(75) Inventor: Alain Neuillet, Noyon (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Saint-Gobain Glass France, Courbevoie (FR)

(21) Appl. No.: 12/530,626

(22) PCT Filed: Mar. 13, 2008
(86) PCT No.: PCT/FR08/50427

§ 371 Date: Jan. 20, 2010

(30) Foreign Application Priority Data
Mar. 13, 2007 (FR) 0753806

(51) Int. Cl. H01J 5/00; B32B 17/06

(52) U.S. Cl. 313/317; 156/106

(57) ABSTRACT

A laminated flat lamp and its manufacturing process, including: two walls in a form of first and second glass sheets held parallel to each other and sealed by an inner seal, defining an internal space including an electrically supplied visible and/or ultraviolet light source; a first electrode associated with a first glass sheet and a second electrode associated with the first or the second glass sheet; at least another glass sheet, as a first glass backing, joined to the first sheet via a plastic interlayer film; and a peripheral seal made of a polymeric material masking the groove external to the seal and extending beyond the edges of the first and second glass sheets.

The invention relates to the field of flat lamps and more particularly to a laminated flat lamp and its manufacturing process.

Among known flat luminous structures there are flat discharge lamps that can be used as decorative or architectural luminaires or can serve for the backlighting of liquid crystal displays.

These flat discharge lamps typically consist of two glass sheets held together with a small gap between them, generally of less than a few millimeters, and hermetically sealed so as to contain a gas under reduced pressure in which an electrical discharge produces radiation generation in the ultraviolet range that excites a photoluminescent material, which then emits visible light.

Document WO 2004/015739 A2 thus discloses a flat laminated discharge lamp which comprises:
two walls in the form of glass sheets held parallel to each other and defining a gas-filled internal space, and the faces of which that are turned toward the internal space are coated with a photoluminescent material;
two electrodes in the form of a uniform layer covering the respective two walls to the outside of this internal space, these electrodes thus generating electric field lines with at least one component perpendicular to the electrodes; and
two glass sheets joined to the walls via plastic interlayer films.

This flat, laminated discharge lamp may be damaged when being handled (during installation, etc.).

The object of the present invention is to make a laminated flat lamp more robust for a lower cost and in a simple and reliable manner.

For this purpose, the present invention provides a laminated flat lamp, which comprises:
two walls in the form of first and second glass sheets held parallel to each other and sealed by an inner seal, defining an internal space provided with an electrically supplied visible and/or ultraviolet (UV) light source;
a first electrode associated with a first glass sheet and a second electrode associated with the first or the second glass sheet; and
at least another glass sheet, called the first glass backing, joined to the first sheet via a plastic interlayer film,
a peripheral seal made of a polymeric material masking the groove external to the seal and extending beyond the edges of the first and second glass sheets.

This peripheral seal according to the invention thus precludes access to the inner seal, ensuring cohesion of the lamp and, where appropriate, retention of the reduced pressure in the internal space.

The polymeric material also enhances the impermeability to liquid water, water vapor and dust.

Of course a polymeric material that adheres to the glass panes and is sufficiently hard may be chosen.

The peripheral seal may preferably fill the groove, thus coming into contact with the inner seal. Therefore a polymeric material compatible with the inner seal, which is preferably non-organic (glass frit, etc.) so as to avoid any contamination in the internal space, is therefore chosen.

The peripheral seal may entirely cover the edge of the first glass sheet, extend the interlayer film or even cover the edge of the first glass backing.

With this covering peripheral seal, the electrical safety is thus enhanced, by preventing any access to the first electrode via its edges, the first electrode being optionally misaligned relative to the first glass sheet. This is particularly crucial when the latter is supplied with high-frequency power.

This covering peripheral seal also protects the current lead circuits (commonly called busbars) placed on the border of the lamp and also the soldered joints for the current supply leads (made of copper, etc.).

When the second electrode is associated with the second glass sheet and in particular when it is also supplied with high-frequency power (for example at a voltage in phase opposition with the voltage applied to the first electrode), this peripheral seal may entirely cover the edge of the second glass sheet and the edges of the second electrode.

It is also possible to provide a peripheral seal of locally adjusted thickness, especially at the ends of the leads for supplying current to the electrodes and one or more optional other electrical conductors. Thus, the ends of these leads are embedded so as to improve their mechanical integrity and their retention.

The polymeric material may be a silicone, a polyurethane, an acrylic mastic, a butyl rubber or a hot-melt adhesive. For example, a bead is formed by extrusion. However, the finishing of the peripheral seal is not optimum, especially at the ends of this seal.

For ease of manufacture, the electrically insulating material may preferably be identical to the plastic of the interlayer film.

For example, flexible used polyurethane (PU), ethylene/vinyl acetate copolymer (EVA) or polyvinyl butyral (PVB) may be chosen.

In a first embodiment, the inner seal may be manufactured using a frame made of interlayer material and forming the seal preferably at the moment of lamination, this frame optionally being able to be spread sufficiently to meet the interlayer film(s).

In a second preferred embodiment, the peripheral seal is formed, partly or preferably entirely, from the interlayer film or films.

The interlayer film is made to flow, which, in particular with predefined dimensions according to the volume to be filled, spreads sufficiently to fill the groove. Typically, the groove has a height of around 2 mm and a width of around 1 mm.

Such a peripheral seal may most particularly be formed during lamination.

Optimally, the peripheral seal may be formed from the interlayer film extending beyond the first glass sheet by at least 0.5 mm, and even more preferably between 1.5 and 6 mm.

As regards the interlayer film, a plastic that does not require passage in an autoclave to guarantee both bonding and sufficient transparency, but one in which simple heating suffices, is preferred.

An EVA-based seal is most particularly chosen, this having moreover suitable dielectric properties, as will be described later.

In the actual lamination process, the polymeric interlayer films have the same dimensions as the first and second glass sheets and flow during lamination, without however filling the groove. Furthermore, the protruding material on the edges of the first and second glass sheets is unattractive and has to be removed.

Also preferably, for better finishing, the external surface of the peripheral seal according to the invention may be preformed, especially domed in the groove, preferably molded.

Thus, the distribution of material is forced by using a mold of shape complementary for the desired shape of the peripheral seal.

With the peripheral seal thus obtained, it is unnecessary to use a frame.

The surface of the peripheral seal may be flat (or in other words of rectangular cross section), smooth or intentionally grooved or serrated. This seal may be profiled, especially for saving on material, being outwardly domed.

The lateral dimension of the peripheral seal, which is preferably a maximum in the groove, may protrude beyond the groove by at least 0.5 mm and preferably up to 6 mm, especially protrude by around 2 mm.

The cross section of the peripheral seal and/or its lateral dimension is not necessarily the same over the entire perimeter of the lamp. For example, the lateral dimension may be larger in the region of the electrical leads, as already seen.

The shape and/or the surface of the mold is therefore adapted accordingly.

The glass panes of the lamp may have substantially the same dimensions, only the interlayer films being protruding, in which case the peripheral seal emerges from the edges of the lamp.

As already indicated, the lamp according to the invention may include another glass sheet, called second glass backing, joined to the second sheet via an interlayer film made of a plastic identical to that of the first interlayer film.

Of course, this other interlayer film may preferably contribute to the formation of the seal, during lamination, and is for example made of EVA. It may extend beyond the second glass sheet by at least 0.5 mm or more preferably between 1.5 and 6 mm.

In a preferred embodiment, the first glass backing and the second sheet or the optional second glass backing, or the protruding glass panes, extend beyond the first glass pane by preferably at least 1 mm and more preferably up to 7 mm, especially about 2 mm. The peripheral seal may then be preferably housed in the space between the internal faces of the protruding glass panes (the faces oriented toward the internal space).

The height between the internal spaces of the protruding glass panes may for example be between 3 and 20 mm.

The lamp may he of any size, for example having an area equal to or greater than 0.1 m².

The invention applies to any type of flat lamp producing UV light and/or light in the visible.

In the case of a UV lamp, a glass pane sufficiently transparent to UV, as described in application FR 2889 886 incorporated here for reference, is chosen for the first and/or second glass sheets.

The material transmitting said UV radiation may be preferably chosen for quartz, silica, magnesium fluoride (MgF₂) or calcium fluoride (CaF₂), a borosilicate glass or a glass with at least 0.05% Fe₂O₃. However, a soda-lime-silica glass, such as the glass PLANILUX sold by Saint-Gobain, has a transmission greater than 80% above 360 mm, which may be sufficient for certain embodiments and certain applications.

The source of visible and/or US light may be of any type: an emitting gas, a photoluminescent material, an almost point-like light-emitting system of the diode type, or an extended source of the organic light-emitting diode (OLED) type.

As gases emitting in the visible, for example for screened light, mention may be made of rare gases (helium, neon, argon, krypton, xenon) or other gases (air, oxygen, nitrogen, hydrogen, chlorine, methane, ethylene, ammonia, etc.) and mixtures thereof.

As gas emitting in the UV, a gas or a gas mixture is used, for example a gas effectively emitting said UV radiation, especially xenon, or mercury or halides, and a gas that can easily be ionized and capable of constituting a plasma (i.e. a plasma gas) such as a rare gas, for example neon, xenon or argon, or else helium, and halides, or else air or nitrogen.

The uses of a flat lamp may be diverse (lamps with monodirectional and/or bidirectional illumination, lamps for decoration, backlighting of displays).

Examples of the use of a UV lamp are given in application FR 2 889 886, which is incorporated here by reference.

The invention applies in particular to any flat lamp supplied with high-frequency power, such as flat discharge lamps.

To supply this type of flat lamp, at least the first electrode is at a potential over V₀ typically of the order of 1 kV and at high frequency, typically of the order of 1 to 100 kHz, and typically with a power of about 100 W.

The electrodes may be coplanar (and therefore associated with the first glass sheet), double coplanar, i.e. with a series of electrodes per glass sheet, preferably offset for better discharge as indicated in application FR 2 890 232, which is incorporated here by reference.

In a preferred embodiment:
the first and second electrodes are associated respectively with the first and second glass sheets;
the first and second electrodes are integrated into said sheets or are on the outside of said sheets, in the form of continuous or discontinuous conductive layers, or of conducting wires.

Of course, at least one of the electrodes may be made of a material transparent to UV and/or transparent in the visible, or made of a material arranged for an overall satisfactory transmission in the visible and/or UV.

The electrodes may thus be in the form of electroconductive layers, for example continuous and deposited directly on one or both glass sheets.

The electrodes may be arrays of conducting wires, for example organized in a grid, integrated into the glass sheet or sheets or into the interlayer film or films.

Finally, the electrodes may be arrays of conducting tracks, for example made of copper, placed on plastic films, for example on PET films.

With the external or integrated electrodes, the glass sheets provide capacitive protection of the electrodes from ion bombardment. Furthermore, the connections to the power supply are much simpler.

The electrical insulation capability of the glass backing/plastic film assembly is however, not optimum as described in patent application WO 2006/090086, which is incorporated here by reference.

It is also preferable to place, between the first electrode and the first glass backing, an electrical conductor separated from the first electrode by at least the plastic interlayer film, this conductor being grounded or connected to a voltage equal to or below 220 V and at a frequency equal to or below 50 Hz.

Like the electrodes, the conductor may for example be a layer or conducting wires.

When the potential V is nonzero, the interlayer film introduces a capacitance that it is useful to limit as far as possible, by choosing an interlayer film (whether a simple or composite film) with a relative permittivity as low as possible, and preferably with a limited thickness, and therefore with a lower cost.

The capacitive interlayer is defined by its loss angle δ and by introducing a capacitance C proportional to the relative permittivity εᵣ.

It may be advantageous to choose:
a tanδ value equal to or less than 0.06 for a frequency between 1 and 100 kHz and for a surface temperature range between 30° C. and 60° C.;
a relative permittivity εᵣ equal to or less than 4.5 for a frequency between 1 and 100 kHz and for a surface temperature range between 30° C. and 60° C.

EVA has tanδ and relative permittivity εᵣ values within these ranges.

To form the peripheral seal, any method of keeping a gap between the first and second glass sheets, while preventing a deformation and/or pinching of the glass sheets, is preferably chosen.

Thus, another subject of the present invention is a process for manufacturing the laminated flat lamp as claimed in one of the preceding claims, in which:
the first and second sealed glass sheets, the associated first and second electrodes, on either side of the glass sheets, the protruding interlayer film(s), the first glass backing and the optional second glass backing are provided; and
the peripheral seal is produced and the lamination carried out in at least a first step by the following operations:
the perimeter of the lamp is surrounded with a mold of internal surface, called the molding surface, which is preferably of equal or greater height than the lamp facing and spaced apart from the first and second sealed glass sheets and at least part of the protruding interlayer film(s),
the assembly is placed in a vacuum-tight system and
a vacuum is applied and the assembly heated so as to make the plastic of the protruding interlayer film(s) flow so that the plastic follows the molding surface and masks the groove.

As already indicated above, the molding operation allows the manufacture of the peripheral seal (dimensions, shape, etc.) to be controlled, this furthermore being carried out during lamination for speed and simplicity of manufacture.

By surrounding the perimeter of the lamp with the mold, the glass backings (whether protruding or not) or the first glass backing and the second glass sheet (whether these are protruding or not) are furthermore aligned, their edges butting against the mold.

In an advantageous design, said protruding glass panes are used and, during the surrounding operation, the molding surface is inserted into the space between the internal faces of the protruding glass panes.

The molding surface may have only projecting ends, and a flat or rounded hollow central part. The molding surface may be an overmolding surface.

In this way, the protruding glass panes then bear against the lateral edges of the molding surface via their internal faces, this offering several advantages:
the lamp thickness is controlled;
the risk of the protruding glasses creeping is eliminated;
a protected (non-flush) seal is obtained; and
the lateral dimensions of the seal are possibly reduced.

Further details and features of the invention will become apparent from the following detail description given in conjunction with the appended drawings in which:

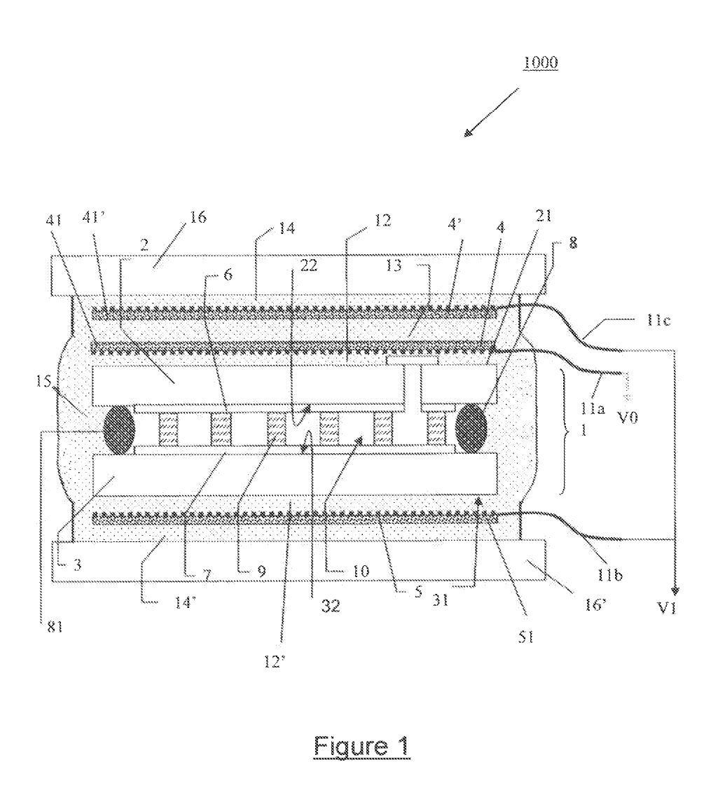

FIG. 1 shows a schematic cross-sectional view of a laminated flat lamp in a first embodiment according to the invention; and

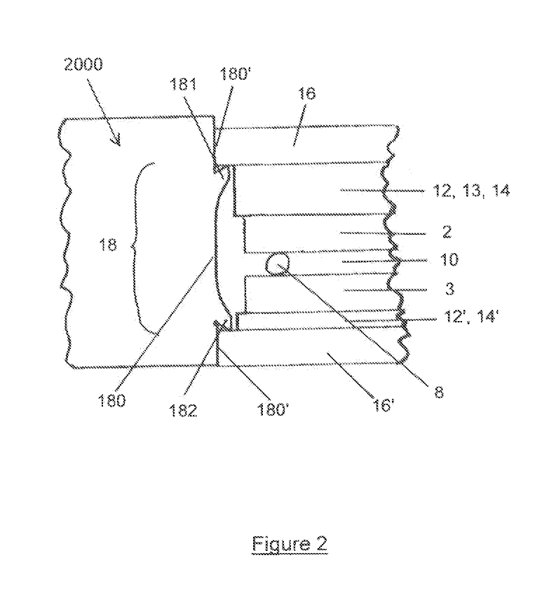

FIG. 2 shows a schematic cross-sectional view of the lamp of FIG. 1 during the manufacture of the peripheral seal.

It should be pointed out that for the sake of clarity the various elements of the objects shown have not been necessarily drawn to scale.

FIG. 1 shows a flat lamp 1000 consisting of a main part 1, formed by first and second glass sheets 2, 3, for example with a thickness of about 3 mm, each having:
outer faces 21, 31 with which the first and second electrodes 4, 5 are associated respectively; and
inner faces 22, 32, each bearing a coating 6, 7 of photoluminescent material, which is for example transparent and for example in the form of phosphor particles dispersed in an inorganic matrix, for example based on lithium silicate.

The glass sheets 2, 3 are associated with their inner faces 22, 32 facing each other and are joined together via a sealing frit 8, for example about 1 mm from the edges, the gap between the glass sheets being imposed (at a value generally of less than 5 mm) by glass spacers 9 placed between the sheets. Here, the spacing is for example about 2 mm.

There is a reduced pressure, generally of the order of 1/10th of an atmosphere, of a rare gas such as xenon, optionally mixed with neon or helium, in what is called the internal space 10 between the glass sheets 2, 3.

Preferably, each electrode 4, 5 is in the form of copper conducting tracks arranged to have a satisfactory overall transmission in the visible, for example tracks with a spacing of 100 μm and with 300 μm between the tracks, and a track width of 10 to 20 μm. The tracks 4, 5 are deposited on the inner faces (that is to say those turned toward the internal space 10) of thin electrical insulators 41, 51, for example made of PET 0.125 mm in thickness.

As a variant, the lamp 1000 may have a single emitting face, the other face having a reflecting element (electrode or the like).

The first and second electrodes 4, 5 are connected to a high-frequency power supply source via leads 11a, 11b.

The first electrode 4 is at a potential V₀ of the order of 1 kV and at a high frequency of 40 to 50 kHz.

The second electrode 5 is at a potential V₁ of around 220 V and at a frequency of 50 Hz, or alternatively it is grounded.

More precisely, starting from the first glass sheet 2, there are placed, in the following order (going outward):
a first EVA interlayer film 12 with a thickness of about 0.16 mm;
the first electrode 4 on its PET film 41;
a second EVA interlayer film 13 with a thickness of about 3.6 mm, forming a capacitive interlayer;
for electrical safety, an electrical conductor 4′, for example of the same design as the first electrode (namely conducting tracks on a PET film), which is electrically supplied via a lead 11c and connected to the second electrode 5;
a third EVA interlayer film 14 with a thickness of about 0.4 mm; and
a first glass backing 16 with a thickness of about 3 mm.

As a variant, the electrical conductor is an electroconductive layer deposited on the inner face of the first glass backing 16 (or a conductor integrated into this glass pane), thereby making it possible to dispense with the interlayer film 14. Likewise, the first electrode 4 may be an electroconductive layer deposited on the outer face 21 of the first glass pane (or a conductor integrated into this glass pane), thereby making it possible to dispense with the interlayer film 12.

More precisely, starting from the second glass sheet 3, there are placed, in the following order (going outward):
EVA interlayer film 12′ with a thickness of about 0.16 mm;
the second electrode 5 on its PET film 51;
another EVA interlayer film 14′ with a thickness of 1.6 mm; and
a second glass backing 16′ with a thickness of about 3 mm.

Likewise, as a variant, the second electrode 5 may be an electroconductive layer deposited on the outer face 31 of the second glass pane 3 (or a conductor integrated into this glass pane), thereby making it possible to dispense with the interlayer film 12′.

The first and second glass backings 16, 16′ are mutually aligned and extend beyond the first glass sheet 2 by about 4 mm.

The laminated flat lamp 1000 is provided with a peripheral seal 15 made of EVA on the perimeter of the lamp and extending between the inner faces of the first and second glass backings 16, 16′ and preferably filling the groove 81 external to the inner seal 8. This peripheral seal 15 also prevents access to the electrodes 4, 5 and to the electrical conductor 4′, and protects the busbars and the soldered joints of the leads (not shown).

This molded seal 15, obtained from the interlayer film setting to 16′ (as described in FIG. 2), has an outwardly domed smooth external surface 150. In the groove 81, the seal 15 projects beyond the glass pane 2 by about 2 mm.

Preferably, the ends of the leads 11a, 11b, 11c are embedded in the peripheral seal 15 for better retention. The seal 15 may be thicker for this purpose.

As a first variant (not shown), the lamp may be a UV lamp with a single emitting face on the side with the second electrode. The phosphors are eliminated and the UV source is a gas in the internal space. The glass sheets are then chosen to be transparent to UV, and a UV reflector is placed, for example one made of alumina, on the inner face of the first glass sheet, or a UV-reflecting first electrode is placed on the outer face.

To let the UV radiation pass through, the second electrode 5 is discontinuous in the form of bans (whether solid bans or in the form of an array of conducting wires or tracks) and the interlayer film and the second glass backing are omitted.

The second glass sheet is preferably chosen to protrude by 4 mm relative to the first glass sheet so as to keep the peripheral seal between two glass panes or, as a variant, all the glass panes have substantially the same dimensions and the seal is then on the edges.

As a second variant (not shown), a lamp based on light-emitting diodes is produced. Again the phosphors and the plasma gas are omitted, the internal space is under vacuum and the electrodes and the safety conductor are omitted. Internal electrodes are used, for example a continuous or discontinuous transparent electroconductive layer, (for example made of fluorine-doped tin oxide) as the inner face of one of the glass sheets or two continuous transparent electroconductive layers on the inner faces of both sheets. As light source, light-emitting diodes are therefore used. Each diode may be a simple semiconductor chip, for example with an active multiple quantum-well layer. Each chip comprises first and second layers of contacts on its opposed faces or on one face in electrical connection with the internal electrodes.

FIG. 2 shows a schematic cross-sectional view of the lamp of FIG. 1 during manufacture of the peripheral seal.

Once the main part 1 has been produced, there are placed, in the following order on the first glass pane 2:
the first EVA interlayer film 12;
the first electrode on its PET film (these not being shown);
a second EVA interlayer film 13;
the electrical conductor for electrical safety (not shown);
the third EVA interlayer film 14;
the first glass backing 16.

Likewise, beneath the second glass sheet 3 there are placed, in the following order:
the EVA interlayer film 12′;
the second electrode on its PET film. (these not being shown);
the other EVA interlayer film 14′;
the second glass backing 16′.

Preferably, all the interlayer films 12, 13, 14, 12′, 14′ extend beyond the first glass pane 2, preferably by at least 2 mm, so as to contribute to the formation of the peripheral seal.

The peripheral seal is produced and the lamination carried out in a single step by the following operations.

The lamp 1000 is surrounded by a mold 2000 made up non-stick material, for example Teflon PTFE, said mold having a height greater than the total height of the lamp and a given area 18, called the molding area, inserted between the protruding glass backings and spaced apart from the interlayer films.

The molding surface 18 has a hollow profile in its central part 180 and protruding ends 181, 182. The molding surface 18 is inserted into the space between the inner faces of the protruding glass backing 16, 16′.

The protruding glass backings 16, 16′ bear via their inner faces against the ends 181, 182 of the molding surface 18, thereby preventing the glass backings from creeping during lamination/molding and allowing the height of the lamp on its periphery to be controlled.

The protruding glass backings 16, 16′ have their edges in abutment against peripheral surfaces 180′ of the mold 2000—the glass backings are thus aligned—the mold 2000 being furthermore capable of absorbing differences in dimensions of the glass backings.

The whole assembly is placed in a vacuum-tight bag. A rough vacuum is created, so as to degas the EVA (elimination of bubbles, etc.), and the assembly is heated to above 100° C. so as to make the EVA plastic of the protruding interlayer films flow. The plastic fills the space between the molding surface 18 and the inner faces of the protruding glass panes 16, 16′, fills the groove 81 external to the inner seal 8 and matches the molding surface 18.

In a lamp variant (not shown), the glass backings are not protruding. In this configuration, a mold with a flat or rounded molding surface, which is not protruding but is simply hollow, is chosen.

1-14. (canceled)

15. A laminated flat lamp, comprising:
two walls in a form of first and second glass sheets held parallel to each other and sealed by an inner seal, defining an internal space including an electrically supplied visible and/or ultraviolet light source;
a first electrode associated with a first glass sheet and a second electrode associated with the first or the second glass sheet;
at least another glass sheet, as a first glass backing, joined to the first sheet via a plastic interlayer film; and
a peripheral seal made of a polymeric material masking a groove external to the seal and extending beyond edges of the first and second glass sheets.

16. The laminated flat lamp as claimed in claim 15, wherein the peripheral seal covers the edge of the first glass sheet and extends the interlayer film.

17. The laminated flat lamp as claimed in claim 15, wherein the polymeric material is identical to the plastic of the interlayer film.

18. The laminated flat lamp as claimed in claim 15, wherein the peripheral seal is formed from the interlayer film, or is formed from the interlayer film during lamination.

19. The laminated flat lamp as claimed in claim 18, wherein the peripheral seal is formed from the interlayer film extending beyond the first glass sheet by at least 0.5 mm.

20. The laminated flat lamp as claimed in claim 15, further comprising current supply leads, each having one of their ends embedded in the peripheral seal.

21. The laminated flat lamp as claimed in claim 15, wherein the polymeric material is based on ethylene/vinyl acetate.

22. The laminated flat lamp as claimed in claim 15, wherein the external surface of the peripheral seal is preformed, and/or is domed in the groove, and/or is molded.

23. The laminated flat lamp as claimed in claim 15, wherein another glass sheet, as a second glass backing, is joined to the second sheet via a second interlayer made of a plastic identical to that of the first interlayer film, the first glass backing and the second sheet or the second glass backing protrude beyond the first glass sheet, the protruding glass panes protruding by at least 1 mm, and the peripheral seal is housed in the space between the internal faces of the protruding glass panes.

24. The laminated flat lamp as claimed in claim 15, wherein the first electrode and the second electrode are associated respectively with the first and second glass sheets, the first and second electrodes being integrated into the sheets or being on the outside of the sheets and in a form of continuous or discontinuous conductive layers, or in a form of conducting wires.

25. The laminated flat lamp as claimed in claim 15, forming a flat discharge lamp, the first electrode being supplied with high-frequency power.

26. The laminated flat lamp as claimed in claim 15, further comprising, between the first electrode and the first glass backing, an electrical conductor separated from the first electrode by at least the plastic interlayer film and grounded or at a voltage equal to or below 220 V and at a frequency equal to or below 50 Hz.

27. A process for manufacturing the laminated flat lamp as claimed in claim 15, in which:
the first and second sealed glass sheets, the associated first and second electrodes, on either side of the glass sheets, the extending interlayer film, and the first glass backing are provided; and
the peripheral seal is produced and lamination carried out in at least a first step by the following operations:
the perimeter of the lamp is surrounded with a mold of internal surface, as a molding surface, facing and spaced apart from the first and second sealed glass sheets and at least part of the protruding interlayer film,
the assembly is placed in a vacuum-tight system, and
a vacuum is applied and the assembly heated so as to make the plastic of the extending interlayer film flow so that the plastic follows the molding surface and masks the groove.

28. The process for manufacturing the flat lamp as claimed in claim 27, wherein protruding glass panes are used and, during a surrounding operation, the molding surface is inserted into the space between internal faces of the protruding glass panes
